(19) United States
(12) Patent Application Publication
(10) Pub. No.: US 2022/0057126 A1
(43) Pub. Date: Feb. 24, 2022

(54) WATER HEATER AND METHOD OF OPERATING SAME

(71) Applicant: Rheem Manufacturing Company, Atlanta, GA (US)

(72) Inventors: Piyush Porwal, Montgomery, AL (US); Raheel Chaudhry, Montgomery, AL (US)

(21) Appl. No.: 16/998,317

(22) Filed: Aug. 20, 2020

(51) Int. Cl. F25B 47/02; F24D 19/10; F24D 17/02; H05B 1/02

(52) U.S. Cl. CPC F25B 47/02; F24D 19/1054; F25B 2500/31; H05B 1/0213; F24D 17/02

(57) ABSTRACT

A method of operating a water heater is disclosed. The method includes obtaining a first input corresponding to ambient temperature and a second input corresponding to evaporator temperature. The method includes determining the ambient temperature from the first input and the evaporator temperature from the second input, followed by determining whether the ambient temperature is less than a first threshold temperature. The method includes determining whether the evaporator temperature is less than a second threshold temperature when the ambient temperature is less than the first threshold temperature, where the second threshold temperature is less than the first threshold temperature. The method also includes actuating a heating element coupled to one or more tubes of the evaporator to heat refrigerant present in the one or more tubes, when the evaporator temperature is less than the second threshold temperature.

### TECHNICAL FIELD

The present disclosure relates, in general, to a water heater and, more specifically relates, to a method of operating the water heater.

### BACKGROUND

Various types of water heaters are known, such as conventional storage tank water heater, tankless water heater, heat pump water heater, solar powered water heater, and condensing water heater. Among these, the heat pump water heater uses the principle of a heat pump, where temperature of the ambient air is utilized to heat water. In particular, a fan of the heat pump water heater is used to blow ambient air over an evaporator, whereby heat of the ambient air is transferred to refrigerant in the evaporator, thus changing liquid refrigerant to gaseous refrigerant. Temperature of the gaseous refrigerant is further increased in a compression stage. Furthermore, the gaseous refrigerant transfers accumulated heat to water or another fluid at a condenser and subsequently passes through an expansion valve to convert back to liquid state. This process typically works efficiently when ambient temperature is sufficient to convert the liquid refrigerant to the gaseous refrigerant. However, in scenarios where the ambient temperature is low, such as in colder regions or during winter weather conditions, conversion of the liquid refrigerant to the gaseous refrigerant can be a challenge. In addition, as the ambient temperature decreases, the refrigerant may solidify and may freeze. Such a frozen condition of the refrigerant, and thus the evaporator, can prevent the water heater from properly functioning ,which can cause inconvenience to users of the heat pump water heater during such low ambient temperature conditions.

### SUMMARY

The present disclosure includes a method of operating a water heater. The method can include obtaining a first input corresponding to ambient temperature from a first sensor and a second input corresponding to evaporator temperature from a second sensor. The first sensor can be coupled to the water heater, and the second sensor can be coupled to an evaporator disposed within the water heater. The method can include determining the ambient temperature from the first input and the evaporator temperature from the second input, followed by determining whether the ambient temperature is less than a first threshold temperature. The method can include determining whether the evaporator temperature is less than a second threshold temperature when the ambient temperature is less than the first threshold temperature, where the second threshold temperature is less than the first threshold temperature. The method can include actuating a heating element coupled to one or more tubes of the evaporator to heat refrigerant present in the one or more tubes, when the evaporator temperature is less than the second threshold temperature.

Actuating the heating element can be achieved by supplying electric current, for a first predetermined time period, to the heating element at a first desired electric current rating. The method can include determining the evaporator temperature after the first predetermined time period and based on the second input obtained from the second sensor. The method can include determining whether the evaporator temperature after the first predetermined time period is less than a third threshold temperature. The third threshold temperature can be less than the first threshold temperature and greater than the second threshold temperature. When it is determined that the evaporator temperature after the first predetermined time period is less than the third threshold temperature, the method can include supplying electric current to the heating element at a second desired electric current rating that is less than the first desired electric current rating. The method can include determining the evaporator temperature after a second predetermined time period based on the second input obtained from the second sensor followed by determining whether the evaporator temperature after the second predetermined time period is greater than the first threshold temperature. The method can include stopping the supply of electric current to the heating element when the evaporator temperature after the second predetermined time period is greater than the first threshold temperature. On the contrary, when the evaporator temperature after the second predetermined time period is less than the first threshold temperature, the method can include supplying electric current to the heating element at the first desired electric current rating to heat the refrigerant present in the one or more tubes of the evaporator.

The method can include, when the ambient temperature is greater than the first threshold temperature, determining whether the evaporator temperature is greater than the first threshold temperature and stopping the supply of electric current to the heating element when the evaporator temperature is determined to be greater than the first threshold temperature.

The method can include determining whether a boost mode of the water heater is enabled and determining whether a compressor of the water heater is powered ON when the boost mode is enabled. When it is determined that the compressor is powered ON, the method can include supplying electric current, for the first predetermined time period, to the heating element at the first desired electric current rating to heat the refrigerant present in the one or more tubes of the evaporator. However, when the compressor is powered OFF, the method can include stopping the supply of electric current to the heating element. The method can include determining whether a freeze protection mode for the water heater is enabled when the boost mode of the water heater is disabled. When it is determined that the freeze protection mode is disabled, the method can include stopping the supply of electric current to the heating element.

The present disclosure also includes a water heater. The water heater can include a circuit having an evaporator, a compressor, a condenser, and an expansion valve sequentially connected by a refrigerant flow path. The water heater can include a fan disposed proximate to the evaporator, and the fan can blow ambient air over the evaporator and a first heating element coupled to one or more tubes of the evaporator and configured to heat refrigerant in the one or more tubes. A first sensor can be coupled to the water heater to sense ambient temperature and a second sensor can be coupled to the evaporator to sense evaporator temperature. The water heater can include a controller communicably coupled to the first heating element, the first sensor, and the second sensor. The controller can be configured to obtain a first input corresponding to the ambient temperature from the first sensor and a second input corresponding to the evaporator temperature from the second sensor. Based on the first input and the second input, the controller can be configured to respectively determine the ambient temperature and the evaporator temperature. The controller can be configured to determine whether the ambient temperature is less than a first threshold temperature and determine whether the evaporator temperature is less than a second threshold temperature when the ambient temperature is less than the first threshold temperature. The second threshold temperature can be less than the first threshold temperature. Further, when the evaporator temperature is less than the second threshold temperature, the controller can be configured to actuate the first heating element to heat the refrigerant present in the tubes of the evaporator. In order to actuate the first heating element, the controller can be configured to supply electric current, for a first predetermined time period, to the first heating element at a first desired electric current rating.

The water heater can include a second heating element disposed between the fan and the evaporator to heat the refrigerant in the one or more tubes of the evaporator. With such arrangement, the controller can be configured to actuate the second heating element to heat the refrigerant, when the evaporator temperature is less than the second threshold temperature.

The present disclosure includes a water heater. The water heater can include an evaporator having one or more tubes configured to allow flow of a refrigerant therein and a heating element coupled to the one or more tubes of the evaporator to heat the refrigerant. The water heater can include a bimetallic switch configured to sense evaporator temperature and actuate the heating element to heat the refrigerant when the evaporator temperature is less than a first threshold evaporator temperature.

The bimetallic switch can be configured to supply electric current to the heating element for a first predetermined time period when the evaporator temperature is less than the first threshold evaporator temperature. However, when the evaporator temperature is greater than the first threshold evaporator temperature, the bimetallic switch can be configured to stop or prevent the supply of electric current to the heating element. The bimetallic switch can be configured to stop or prevent the supply of electric current to the heating element when the evaporator temperature is greater than a second threshold evaporator temperature and supply electric current to the heating element until the evaporator temperature is less than the second threshold evaporator temperature.

These and other aspects and features of non-limiting embodiments of the present disclosure will become apparent to those skilled in the art upon review of the following description of specific non-limiting embodiments of the disclosure in conjunction with the accompanying drawings.

### BRIEF DESCRIPTION OF THE DRAWINGS

A better understanding of embodiments of the present disclosure (including alternatives and/or variations thereof) may be obtained with reference to the detailed description of the embodiments along with the following drawings, in which:

FIG. 1 is a schematic diagram of a circuit of a water heater showing a heating element attached to an evaporator;

FIG. 2 is a block diagram showing components of the water heater;

FIG. 3 is a flowchart of a method of operating the water heater in evaporator de-freezing mode;

FIG. 4 is a flowchart of a method of operating the water heater in a boost mode;

FIG. 5A shows a bimetallic switch coupled to an evaporator of the water heater;

FIG. 5B is a flowchart showing operation executed by the bimetallic switch of FIG. 5A; and

FIG. 6 is a schematic diagram of the circuit of the water heater showing another heating element disposed proximal to the evaporator.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

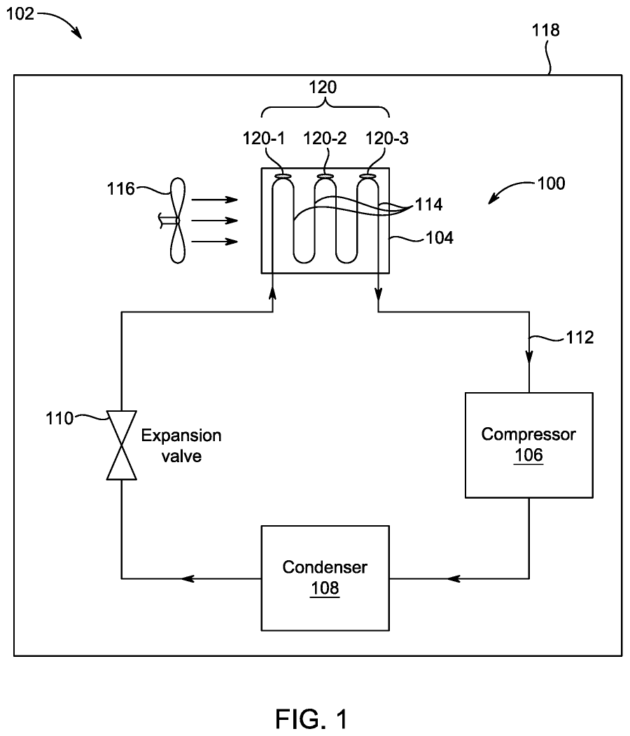

Referring to FIG. 1, a schematic diagram of a circuit 100 of a water heater 102 is illustrated. The circuit 100 can include an evaporator 104, a compressor 106, a condenser 108, and an expansion valve 110 sequentially connected by a refrigerant flow path 112. The evaporator 104 can include one or more tubes 114 (hereinafter referred to as ‘the tubes 114’) configured to allow flow of refrigerant therein. A fan 116 can be disposed proximate to the evaporator 104 to blow ambient air towards the evaporator 104 and to enhance heat exchange efficiency of the evaporator 104. A person skilled in the art would appreciate that the circuit 100 and the fan 116 can be housed in a cabinet 118 that is typically located adjacent to a container (not shown) adapted to store water heated with aid of the circuit 100. Alternatively, the circuit 100 and the fan 116 can be housed at a top portion of a vertically extending water heater, where a bottom portion is adapted to contain water. The water heater 102 can include multiple heating elements 120-1, 120-2, 120-3, collectively and commonly referred to as ‘the heating element 120’, coupled to the tubes 114 of the evaporator 104. As an example, the heating element 120 can be coupled to return bend sections of the tubes 114 as shown in FIG. 1, to heat the refrigerant flowing through the tubes 114. As used herein, the phrase ‘return bend sections’ can refer to portions of the tubes 114 which allow flow of refrigerant entering the evaporator 104 transferring heat to the water at the condenser 108. The heating element 120 is alternatively referred to as ‘the first heating element 120’ in the present disclosure. As an example, the heating element 120 can be embodied as a plate made of ceramic material (e.g., measuring about 3 inch by 1 inch in size).

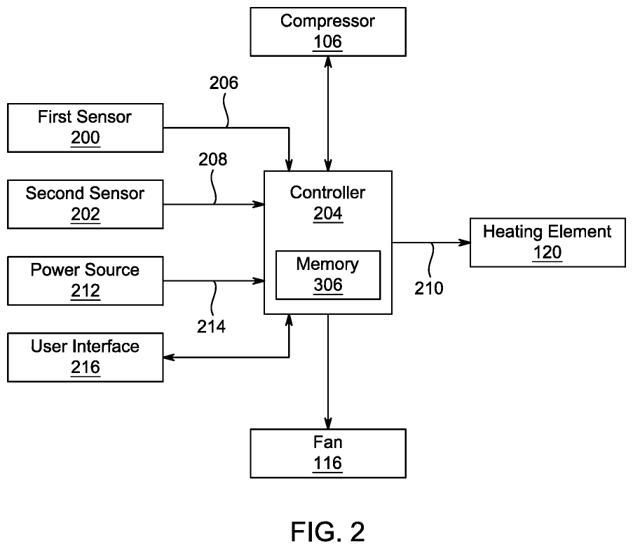

Referring to FIG. 2, a block diagram of the water heater 102 is shown. For the purpose of brevity in description, components associated with the heating of the tubes 114 of the evaporator 104 of the water heater 102 are illustrated through an exemplary block diagram. The water heater 102 can include a first sensor 200 configured to sense ambient temperature ‘T_{A}’ and a second sensor 202 configured to sense temperature of the evaporator 104. For purpose of convenience, the ‘temperature of the evaporator 104’ is hereinafter alternatively referred to as ‘the evaporator temperature’ denoted by ‘T_{E}’. As an example, the first sensor 200 can be coupled to a top portion of the cabinet 118 such that the first sensor 200 can be exposed to the environment to sense the ambient temperature ‘T_{A}’ with high precision and the second sensor 202 can be coupled to the evaporator 104, particularly to the tubes 114 of the evaporator 104, to sense the evaporator temperature ‘T_{E}’. It will be appreciated by the person skilled in the art that the phrase ‘evaporator temperature’ may also be referred to temperature of the refrigerant. The second sensor 202 can be coupled to the evaporator 104 at a location so as to not be under the influence of ambient air current from the fan 116, which can cause the second sensor 202 to sense false temperature.

The water heater 102 can include a controller 204. As an example, the controller 204 can be a processor that includes a single processing unit or a number of processing units. The explicit use of the term ‘processor’ should not be construed to refer exclusively to hardware capable of executing a software application. Rather, in this example, the controller 204 can be implemented as one or more microprocessors and/or logic circuitries capable of manipulating signals based on operational instructions. Among the capabilities mentioned herein, the controller 204 can also be configured to receive, transmit, and execute computer-readable instructions.

The controller 204 can be communicably coupled to the first sensor 200 through a first channel 206 to obtain a first input corresponding to the ambient temperature ‘T_{A}’ and to the second sensor 202 through a second channel 208 to obtain a second input corresponding to the evaporator temperature ‘T_{E}’. As an example, both or either of the first channel 206 and the second channel 208 can be implemented as wired channel or wireless channel. Based on the first input and the second input, the controller 204 can be configured to determine value of the ambient temperature ‘T_{A}’ and the evaporator temperature ‘T_{E}’, respectively. Additionally, the heating element 120 can be coupled to the controller 204 through a third channel 210. A power source 212 coupled to the controller 204 through a fourth channel 214 can aid heating of the heating element 120. The third channel 210 and the fourth channel 214 can be implemented as a continuous channel extending between the power source 212 and the heating element 120. In such arrangement, the controller 204 can selectively operate the power source 212 to supply electric current to the heating element 120. Alternatively or additionaly, the controller 204 can be coupled to the compressor 106 to determine a powered status thereof, such as powered ON and powered OFF, and to the fan 116 to control operation of the fan 116.

Further, the water heater 102 can include a user interface 216 coupled to the controller 204. As an example, the user interface 216 can be implemented as a display device (not shown) to provide various information, such as, but not limited to, value of the ambient temperature ‘T_{A}’, value of the evaporator temperature ‘T_{E}’, speed of the fan 116, and temperature of heated water stored in the container. As another example, the user interface 216 can be implemented as a touchscreen device to allow a user to provide input to control operation of the water heater 102. As yet another example, the user interface 216 can be communicably coupled with a remote device (not shown) used by the user to provide the input.

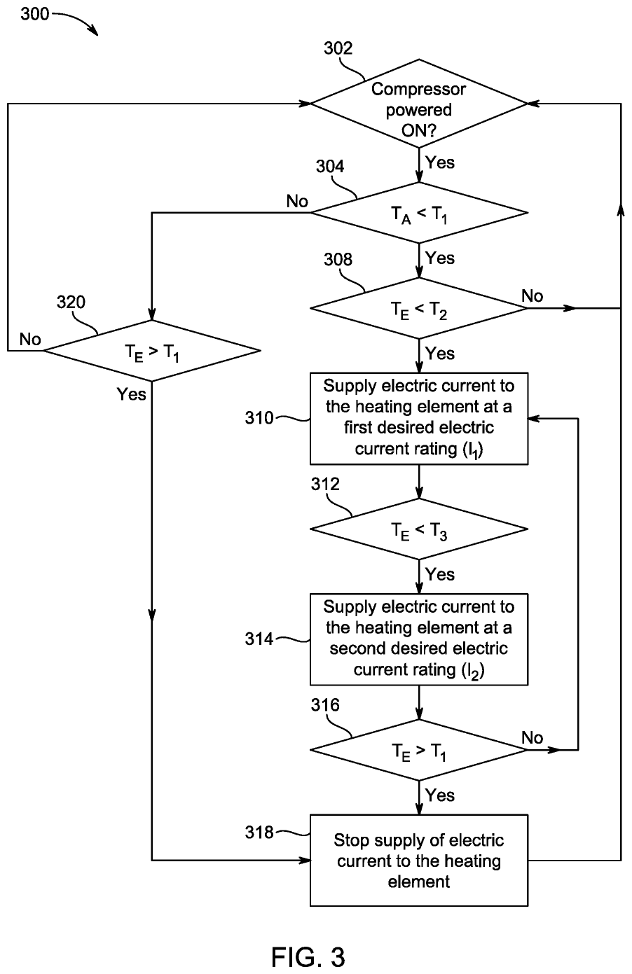

FIG. 3 is a flowchart of a method 300 of operating the water heater 102 according to the present disclosure. Particularly, the method 300 is directed to prevent a frost condition of the evaporator 104 or to defreeze the refrigerant in the evaporator 104. The method 300 will be described in conjunction with the FIG. 1 and the FIG. 2. The order in which the method 300 is described is not intended to be construed as a limitation, and any number of the described method blocks can be combined in any order to implement the method 300. Additionally, individual blocks may be deleted from the method 300 without departing from the scope of the present disclosure. Furthermore, the method 300 can be implemented in any suitable hardware, software, or a combination thereof. However, for ease of description, as described below, the method 300 is considered executed by the controller 204.

At step 302, the method 300 can include determining whether the compressor 106 is powered ON. Since the controller 204 can be coupled to the compressor 106 (as shown in FIG. 2), the powered status of the compressor 106 can be determined by the controller 204. Alternatively, multiple devices and methods can be employed to enable the controller 204 to determine the powered status of the compressor 106.

At step 304, the method 300 can include determining whether the ambient temperature ‘T_{A}’ is less than a first threshold temperature ‘T₁’. Once the controller 204 has determined the ambient temperature ‘T_{A}’ based on the first input from the first sensor 200, the controller 204 can be configured to determine whether the ambient temperature ‘T_{A}’ is less than the first threshold temperature ‘T₁’. The first threshold temperature ‘T₁’ can be stored in a memory 306 (see FIG. 2) of the controller 204. The first threshold temperature ‘T₁’ can be predetermined based on minimum temperature required to prevent frosting of the refrigerant flowing through the evaporator 104. It will be understood that a freezing temperature varies with the refrigerant used in the circuit 100. Accordingly, the user can be allowed to vary the first threshold temperature ‘T₁’ using the user interface 216. As an example, the first threshold temperature ‘T₁’ can be 50° F.

At step 308, the method 300 can include determining whether the evaporator temperature ‘T_{E}’ is less than a second threshold temperature ‘T₂’, when the ambient temperature ‘T_{A}’ is less than the first threshold temperature ‘T₁’. The second threshold temperature ‘T₂’ can be set at a temperature that is less than the first threshold temperature ‘T₁’. The second threshold temperature ‘T₂’ can be stored in the memory 306 of the controller 204. As an example, the second threshold temperature ‘T₂’ can be 35° F. For instance, the refrigerant in the evaporator 104 can freeze at a temperature of about 32° F., and the second threshold temperature ‘T₂’ can be preset to be a few degrees greater than the refrigerant freezing temperature, so that the difference between such refrigerant freezing temperature and the second threshold temperature ‘T₂’ can trigger execution of the method 300 to prevent freezing of the refrigerant.

At step 310, the method 300 can include actuating the heating element 120 to heat the refrigerant present in the tubes 114 of the evaporator 104. The method 300 at step 310 can include supplying the electric current, for a first predetermined time period, to the heating element 120 at a first desired electric current rating ‘I₁’, when the evaporator temperature ‘T_{E}’ is less than the second threshold temperature ‘T₂’. The phrase ‘first predetermined time period’ can be understood as a minimum time period of continuous heating of the heating element 120 required to determine an increase in the evaporator temperature ‘T_{E}’. The phrase ‘electric current rating’ can be understood as a rated amount of current that can be handled by the heating element 120 and the phrase ‘first desired electric current rating’ can be understood as a predetermined percentage of the electric current rating of the heating element 120.

The controller 204 can configured to control flow of electric current to the heating element 120 from the power source 212. Additionally, the controller 204 can configured to actuate the heating element 120 (e.g., by supplying 100% of maximum rated amount of current to the heating element 120). Such supply of the electric current can aid faster heating of the heating element 120 and, subsequently, heating of the refrigerant in the tubes 114 of the evaporator 104. However, during the heating of the tubes 114 by the heating element 120, continued blowing of ambient air by the fan 116 and towards the evaporator 104 can reduce efficiency of heating. Accordingly, the controller 204 can be configured to control operation of the fan 116 so that the heating of the tubes 114 of the evaporator 104 is not negatively affected by the fan 116. Thus, the controller 204 can be configured to reduce speed of the fan 116 when the electric current is being supplied to the heating element 120. Alternatively or additionally, the controller 204 can be configured to stop operation of the fan 116 when the electric current is being supplied to the heating element 120.

At step 312, the method 300 can include determining the evaporator temperature ‘T_{E}’, after the first predetermined time period, based on the second input obtained from the second sensor 202. The method 300, at step 312, can include determining whether the evaporator temperature ‘T_{E}’ after the first predetermined time period is less than a third threshold temperature ‘T₃’. The third threshold temperature ‘T₃’ can be set to a temperature that is less than the first threshold temperature ‘T₁’ and greater than the second threshold temperature ‘T₂’. As an example, the third threshold temperature ‘T₃’ can be 45° F. With the aid of the second channel 208 extending between the controller 204 and the second sensor 202, the controller 204 can continuously receive the second input corresponding to the evaporator temperature ‘T_{E}’. As such, the controller 204 can be configured to continuously determine the evaporator temperature ‘T_{E}’. As an example, the determined evaporator temperature ‘T_{E}’ can be displayed on the user interface 216.

Upon reaching the first predetermined time period, such as, for example 15 minutes, the controller 204 can be configured to momentarily stop the supply of electric current to the heating element 120. The heat already accumulated in the heating element 120 can continue to heat the refrigerant in the tubes 114 of the evaporator 104. Therefore, after the first predetermined time period, the evaporator temperature ‘T_{E}’ can increase by a certain value. However, it is required to maintain the evaporator temperature ‘T_{E}’ below a maximum temperature of the refrigerant. Here, the phrase ‘maximum temperature of the refrigerant’ can be understood as a suction temperature limitation of the compressor 106. Thus, the momentary stop of supply of the electric current to the heating element 120 can prevent the refrigerant from reaching the maximum temperature.

Further, upon reaching the first predetermined time period, if the controller 204 determines the evaporator temperature ‘T_{E}’ to be greater than the third threshold temperature ‘T₃’, the controller 204 can be configured to not subsequently resume the supply of the electric current to the heating element 120.

At step 314, the method 300 can include supplying the electric current to the heating element 120 at a second desired electric current rating 12′ when the evaporator temperature ‘T_{E}’ is less than the third threshold temperature ‘T₃’. The second desired electric current rating 12′ can be set to a temperature that is less than the first desired electric current rating ‘I₁’. The controller 204 can be configured to control the power source 212 to supply the electric current (e.g., up to 50% of the maximum rated amount of electric current) to the heating element 120. Although the second desired electric current rating ‘I₂’ is described as being 50% of the maximum rated amount of electric current, the second desired electric current rating ‘I₂’ can be set to any desired percentage of the maximum rated amount of electric current or any desired percentage of the first desired electric current rating ‘I₁’, based on the refrigerant used in the circuit 100.

The controller 204 can be configured to vary the second desired electric current rating ‘I₂’ over successive time intervals. For instance, at the step 312, consider the evaporator temperature ‘T_{E}’ as 38 ° F. and the third threshold temperature ‘T₃’ as 45° F. The controller 204 can be configured to control the power source 212 to supply the electric current up to 80% of the maximum rated amount of electric current to the heating element 120. After a short duration, the evaporator temperature ‘T_{E}’ can be 41° F. and the controller 204 can be configured to control the power source 212 to supply the electric current up to 40% of the maximum rated amount of electric current to the heating element 120. Since the controller 204 continuously determines the evaporator temperature ‘T_{E}’ based on the second input from the second sensor 202, the controller 204 can be configured to vary the second desired electric current rating ‘I₂’ until the evaporator temperature ‘T_{E}’ is less than the third threshold temperature ‘T₃’. Thus, once the evaporator temperature ‘T_{E}’ is equal to the third threshold temperature ‘T₃’ or when the evaporator temperature ‘T_{E}’ rises beyond the third threshold temperature ‘T₃’, the controller 204 can be configured to stop the supply of the electric current to the heating element 120.

At step 316, the method 300 can include determining the evaporator temperature ‘T_{E}’ after a second predetermined time period, such as, for example 10 minutes, based on the second input obtained from the second sensor 202. The method 300, at the step 316, can include determining whether the evaporator temperature ‘T_{E}’ after the second predetermined time period is greater than the first threshold temperature ‘T₁’. It should be noted here that while the refrigerant flows through the circuit 100, temperature of the refrigerant is first increased in the compressor 106 and subsequently the refrigerant transfers heat to the water at the condenser 108. Further, when the refrigerant passes through the expansion valve 110, temperature of the refrigerant decreases and the refrigerant reaches the evaporator 104 where the heat accumulated in the heating element 120 heats the refrigerant. The second predetermined time period can allow the refrigerant to complete one or more cycles through the circuit 100. Hence, at the step 316, determining the evaporator temperature ‘T_{E}’ after the second predetermined time period can enable the controller 204 to control heating of the heating element 120.

Upon reaching the second predetermined time period, the controller 204 can be configured to determine whether the evaporator temperature ‘T_{E}’ is greater than the first threshold temperature ‘T₁’, such as 50° F. The evaporator temperature ‘T_{E}’ can be compared to a fourth threshold temperature ‘T₄’. In order to accommodate hysteresis, a delta value, for example 5° F., can be considered for the third threshold temperature ‘T₃’. The delta value added to the third threshold temperature ‘T₃’ can result in the fourth threshold temperature ‘T₄’. For example, 45° F.+5° F.=50° F. The controller 204 can be configured to determine whether the evaporator temperature ‘T_{E}’ is greater than the fourth threshold temperature ‘T₄’.

At step 318, the method 300 can include stopping the supply of electric current to the heating element 120 when the evaporator temperature ‘T_{E}’ is greater than the first threshold temperature ‘T₁’ or the fourth threshold temperature ‘T₄’. However, at step 316, if the evaporator temperature ‘T_{E}’ is less than the first threshold temperature ‘T₁’ or the fourth threshold temperature ‘T₄’, the method 300 can include supplying the electric current at the first desired electric current rating ‘I₁’ to the heating element 120.

Referring back to step 304, if the ambient temperature ‘T_{A}’ is greater than the first threshold temperature ‘T₁’, the method 300, at step 320, can include determining whether the evaporator temperature ‘T_{E}’ is greater than the first threshold temperature ‘T₁’. The method 300 can include stopping the supply of electric current to the heating element 120 when the evaporator temperature ‘T_{E}’ is greater than the first threshold temperature ‘T₁’. However, at step 320, if the evaporator temperature ‘T_{E}’ is less than the first threshold temperature ‘T₁’, the method 300 can include determining whether the compressor 106 is powered ON.

Likewise, referring back to step 308, if the evaporator temperature ‘T_{E}’ is greater than the second threshold temperature ‘T₂’, the method 300 can include determining whether the compressor 106 is powered ON.

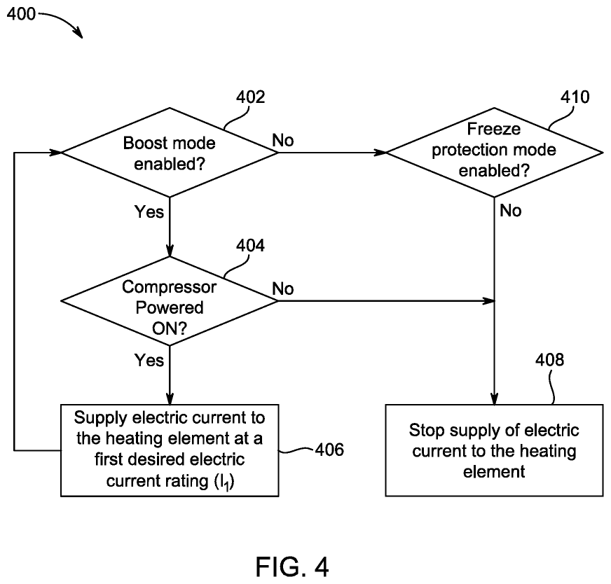

FIG. 4 illustrates a flowchart of a method 400 of operating the water heater 102, according to the present disclosure. The method 400 can be executed by the controller 204. At step 402, the method 400 can include determining whether a boost mode of the water heater 102 is enabled. The phrase ‘boost mode’ can be understood as a mode of operation of the water heater 102 to increase availability of amount of hot water during peak hours or during high use periods. Alternatively or additionally, the boost mode can be understood as a mode of operation of the water heater 102 to increase availability of the hot water in a short period of time when the ambient temperature ‘T_{A}’ is low, such as during winter weather conditions. A booster (not shown) can be employed to add additional heat to the evaporator 104, thereby causing the refrigerant to heat the water. Alternatively or additionally, the boost mode can be enabled in the water heater 102 through the user interface 216. For example, the user can be allowed to set the water heater 102 to operate in the boost mode for a desired time period. The required temperature of water, or the desired time period, or both can be input through the user interface 216 and the controller 204 can actuate the heating element 120 according to the user input.

At step 404, the method 400 can include determining whether the compressor 106 is powered ON when the boost mode is enabled.

At step 406, the method 400 can include supplying the electric current, for the first predetermined time period, to the heating element 120 at the first desired electric current rating ‘I₁’ to heat the refrigerant present in the tubes 114 of the evaporator 104 when the compressor 106 is powered ON. The manner in which the electric current supplied to the heating element 120 at the first desired electric current rating ‘I₁’ can be similar to that described at the step 310 of the method 300 of FIG. 3.

If, at step 404, it is determined that the compressor 106 is powered OFF, the method 400 can include stopping the supply of electric current to the heating element 120.

If, at step 402, it is determined that the boost mode is disabled, the method 400 can include determining whether a freeze protection mode for the water heater 102 is enabled. The ‘freeze protection mode’ can be understood as a mode of operation of the water heater 102 to prevent freezing of evaporator coil. The controller 204 can be configured to determine if the freeze protection mode is selected. Accordingly, the controller 204 can provide notification on the user interface 216. A freeze protection threshold temperature can be stored in the memory 306 of the controller 204. Particularly, the freeze protection threshold temperature can be set to a few degrees (e.g., 1 degree, 2 degrees, 3 degrees, 4 degrees, 5 degrees, 6 degrees) above a freezing temperature of the evaporator coil as a safety precaution.

If, at step 410, it is determined that the freeze protection mode is enabled, the method 400 includes stopping supply of the electric current to the heating element 120.

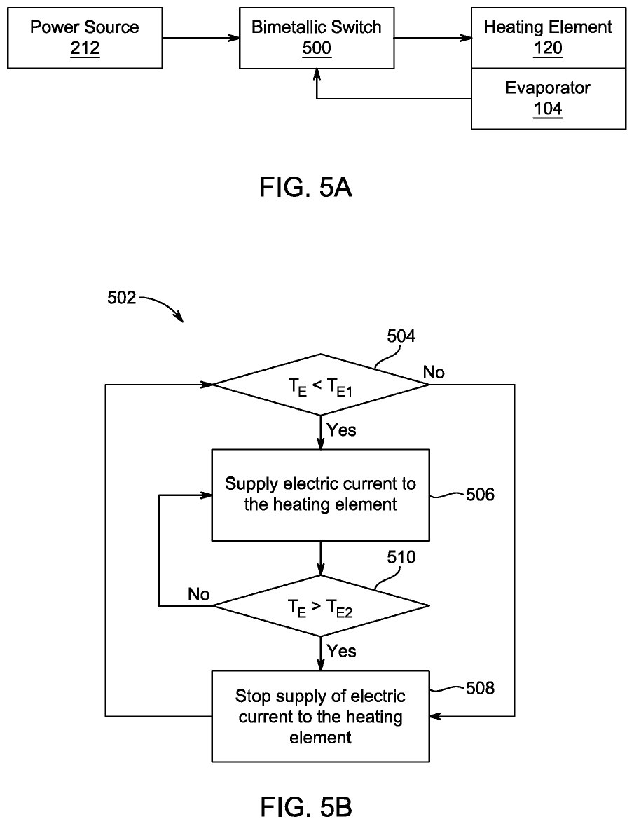

FIG. 5A illustrates a block diagram of the water heater 102, according to another embodiment of the present disclosure. Instead of the controller 204 for actuating the heating element 120, FIG. 5A contemplates the use of a bimetallic switch 500 configured to actuate the heating element 120. It will be known to the person skilled in the art that the bimetallic switch 500 is a component that can be used to cause a certain change, for example switching OFF or ON another component based on a temperature input. The bimetallic switch 500 can be coupled between the power source 212 and the heating element 120 and can be configured to allow or prevent the supply of electric current to the heating element 120 based on the evaporator temperature ‘T_{E}’.

FIG. 5B illustrates a flowchart showing operation 502 executed by the bimetallic switch 500. At step 504, the bimetallic switch 500 can be configured to sense the evaporator temperature ‘T_{E}’ and determine whether the evaporator temperature ‘T_{E}’ is less than a first threshold evaporator temperature ‘T_{E}’.

At step 506, the bimetallic switch 500 can be configured to actuate the heating element 120 to heat the refrigerant present in the tubes 114 of the evaporator 104 when the evaporator temperature ‘T_{E}’ is less than the first threshold evaporator temperature ‘T_{E1}’. The bimetallic switch 500 can be configured to supply electric current to the heating element 120 for the first predetermined time period.

When the evaporator temperature ‘T_{E}’ is greater than the first threshold evaporator temperature ‘T_{E1}’, the bimetallic switch 500, at step 508, can be configured to stop the supply of electric current to the heating element 120.

On reaching the first predetermined time period, at step 510, the bimetallic switch 500 can be configured to determine whether the evaporator temperature ‘T_{E}’ is greater than a second threshold evaporator temperature ‘T_{E2}’. If, at step 510, the evaporator temperature ‘T_{E}’ is greater than the second threshold evaporator temperature ‘T_{E2}’, then the bimetallic switch 500 can be configured to stop or prevent the supply of electric current to the heating element 120. However, if the evaporator temperature ‘T_{E}’ is less than the second threshold evaporator temperature ‘T_{E2}’, the bimetallic switch 500 can be configured to continue supply of the electric current to the heating element 120 until the evaporator temperature ‘T_{E}’ is equal to or greater than the second threshold evaporator temperature ‘T_{E2}’.

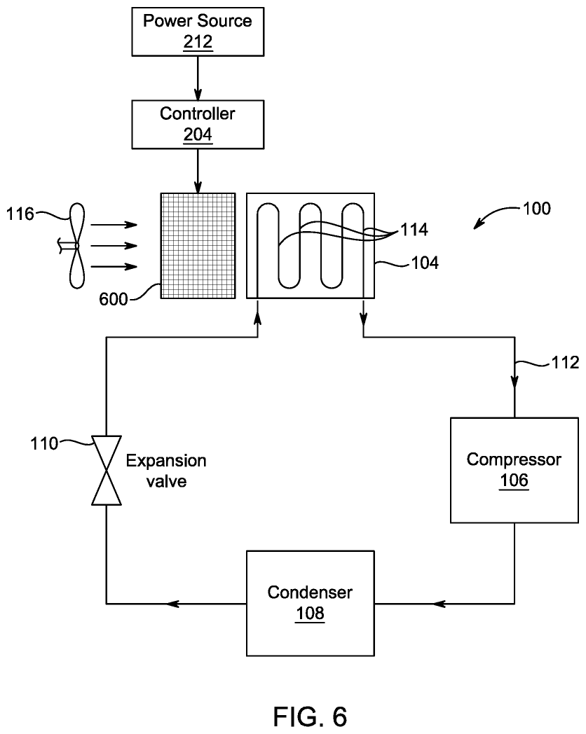

FIG. 6 illustrates a schematic diagram of the circuit 100 of the water heater 102 according to another embodiment of the present disclosure. The water heater 102 can include a second heating element 600 disposed between the fan 116 and the evaporator 104. Optionally, the second heating element 600 can be disposed at a location of an air filter. Therefore, the second heating element 600 can be included without negatively affecting compactness of the water heater 102. The second heating element 600 can be an electrical resistance heating grid, as an example. In operation, the controller 204 can be configured to actuate the second heating element 600 to heat the refrigerant present in the tubes 114 of the evaporator 104 during the various conditions described in FIG. 3 and FIG. 4. When the fan 116 blows the ambient air towards the evaporator 104, the ambient air can flow past the second heating element 600 and can absorb the heat from the second heating element 600. Therefore, the temperature of the ambient air can be increased. The heated ambient air in turn can heat the tubes 114 of the evaporator 104 by forced convection, and eventually, the heat can be absorbed by the refrigerant flowing through the tubes 114. When the water heater 102 is equipped with the bimetallic switch 500, actuation of the second heating element 600 can be similar to that described with respect to FIG. 5B.

The water heater 102 can be equipped with the first heating element 120 and the second heating element 600. In such configuration of the water heater 102, the controller 204 can be configured to actuate both the first heating element 120 and the second heating element 600.

### INDUSTRIAL APPLICABILITY

The present disclosure provides the methods 300 and 400 which can be implemented in a heat pump water heater, such as the water heater 102. Since the controller 204 is able to efficiently and precisely determine the evaporator temperature ‘T_{E}’ and accordingly actuate the heating element 120 to heat the refrigerant present in the tubes 114 of the evaporator 104, the methods 300 and 400 can eliminate or reduce the possibility of frosting of the evaporator 104, thereby enhancing user convenience. Further, since a built-in controller of the water heater 102 can be configured to execute functions of the controller 204 described above, requirement of a separate controller can be eliminated or minimized, thereby substantially lowering the overall cost of the water heater 102.

While aspects of the present disclosure have been particularly shown and described with reference to the embodiments above, it will be understood by those skilled in the art that various additional embodiments may be contemplated by the modification of the disclosed methods without departing from the spirit and scope of what is disclosed. Such embodiments should be understood to fall within the scope of the present disclosure as determined based upon the claims and any equivalents thereof

What is claimed is:

1. A method of operating a water heater, the method comprising:
obtaining a first input corresponding to an ambient temperature from a first sensor, the first sensor coupled to the water heater;
obtaining a second input corresponding to an evaporator temperature from a second sensor coupled to an evaporator disposed within the water heater;
determining the ambient temperature from the first input;
determining the evaporator temperature from the second input;
determining whether the ambient temperature is less than a first threshold temperature;
in response to the ambient temperature being less than the first threshold temperature, determining whether the evaporator temperature is less than a second threshold temperature that is less than the first threshold temperature; and
in response to the evaporator temperature being less than the second threshold temperature, actuating a heating element coupled to one or more tubes of the evaporator to heat refrigerant present in the one or more tubes of the evaporator.

2. The method of claim 1 further comprising:
in response to the evaporator temperature being less than the second threshold temperature, supplying electric current, for a first predetermined time period, to the heating element at a first desired electric current rating to heat the refrigerant present in the one or more tubes of the evaporator.

3. The method of claim 2 further comprising:
determining the evaporator temperature after the first predetermined time period based on a third input obtained from the second sensor; and
determining whether the evaporator temperature after the first predetermined time period is less than a third threshold temperature, wherein the third threshold temperature is less than the first threshold temperature and greater than the second threshold temperature.

4. The method of claim 3 further comprising:
supplying electric current to the heating element at a second desired electric current rating when the evaporator temperature after the first predetermined time period is less than the third threshold temperature, wherein the second desired electric current rating is less than the first desired electric current rating.

5. The method of claim 4 further comprising:
determining the evaporator temperature after a second predetermined time period based on a fourth input obtained from the second sensor;
determining whether the evaporator temperature after the second predetermined time period is greater than the first threshold temperature; and
in response to determining that the evaporator temperature after the second predetermined time period being greater than the first threshold temperature, stopping the supply of electric current to the heating element.

6. The method of claim 5 further comprising:
in response to the evaporator temperature after the second predetermined time period being less than the first threshold temperature, supplying electric current to the heating element at the first desired electric current rating to heat the refrigerant present in the one or more tubes of the evaporator.

7. The method of claim 5 further comprising:
in response to the ambient temperature being greater than the first threshold temperature, determining whether the evaporator temperature is greater than the first threshold temperature; and
in response to the evaporator temperature being greater than the first threshold temperature, stopping the supply of electric current to the heating element.

8. The method of claim 2 further comprising:
in response to determining that a boost mode of the water heater is enabled, determining whether a compressor of the water heater is powered ON; and
in response to determining that the compressor the water heater is powered ON, supplying electric current, for the first predetermined time period, to the heating element at the first desired electric current rating to heat the refrigerant present in the one or more tubes of the evaporator.

9. The method of claim 8 further comprising:
in response to the compressor being powered OFF, stopping the supply of electric current to the heating element.

10. The method of claim 8 further comprising:
in response to determining that a boost mode of the water heater is disabled, determining whether a freeze protection mode for the water heater is enabled; and
in response to determining that the freeze protection mode is disabled, stopping the supply of electric current to the heating element.

11. A water heater comprising:
a circuit comprising an evaporator, a compressor, a condenser, and an expansion valve sequentially connected by a refrigerant flow path;
a fan disposed proximate to the evaporator, the fan configured to blow ambient air across the evaporator;
a first heating element configured to heat refrigerant in one or more tubes of the evaporator;
a first sensor configured to detect ambient temperature;
a second sensor configured to detect evaporator temperature; and
a controller communicably coupled to the first heating element, the first sensor, and the second sensor, wherein the controller is configured to:
obtain a first input corresponding to the ambient temperature from the first sensor;
obtain a second input corresponding to the evaporator temperature from the second sensor;
determine the ambient temperature from the first input;
determine the evaporator temperature from the second input;
determine whether the ambient temperature is less than a first threshold temperature;
in response to the ambient temperature being less than the first threshold temperature, determine whether the evaporator temperature is less than a second threshold temperature that is less than the first threshold temperature; and
in response to the evaporator temperature being less than the second threshold temperature, actuate the first heating element to heat the refrigerant present in the one or more tubes of the evaporator.

12. The water heater of claim 11 further comprising a second heating element disposed between the fan and the evaporator, the second heating element configured to heat the refrigerant in the one or more tubes of the evaporator, wherein the controller is configured to actuate the second heating element to heat the refrigerant present in the one or more tubes in response to determining that the evaporator temperature is less than the second threshold temperature.

13. The water heater of claim 11, wherein the controller is configured to output instructions for supplying electric current, for a first predetermined time period, to the first heating element at a first desired electric current rating to heat the refrigerant present in the one or more tubes of the evaporator, in response to determining that the evaporator temperature is less than the second threshold temperature.

14. A water heater comprising:
an evaporator comprising one or more tubes configured to allow flow of a refrigerant therein;
a heating element coupled to the one or more tubes of the evaporator and configured to heat the refrigerant; and
a bimetallic switch configured to:
detect an evaporator temperature; and
actuate the heating element to heat the refrigerant present in the one or more tubes of the evaporator when the evaporator temperature is less than a first threshold evaporator temperature.

15. The water heater of claim 14, wherein the bimetallic switch is configured to supply electric current to the heating element for a first predetermined time period when the evaporator temperature is less than the first threshold evaporator temperature.

16. The water heater of claim 15, wherein the bimetallic switch is configured to prevent the supply of electric current to the heating element when the evaporator temperature is greater than the first threshold evaporator temperature.

17. The water heater of claim 16, wherein the bimetallic switch is configured to prevent the supply of electric current to the heating element when the evaporator temperature is greater than a second threshold evaporator temperature.

18. The water heater of claim 17, wherein the bimetallic switch is configured to supply electric current to the heating element when the evaporator temperature is less than the second threshold evaporator temperature.
